(19) United States
(12) Patent Application Publication
(10) Pub. No.: US 2005/0026036 A1
(43) Pub. Date: Feb. 3, 2005

(54) Battery

(75) Inventors: Hirokazu Kimiya, Kyoto-shi (JP); Shinji Kasamatsu, Katano-shi (JP); Hajime Nishino, Ikoma-shi (JP); Kazuhiro Okamura, Hirakata-shi (JP); Mikinari Shimada, Yawata-shi (JP)

Correspondence Address: PARKHURST & WENDEL, L.L.P., 1421 PRINCE STREET, SUITE 210, ALEXANDRIA, VA, 22314-2805, US

(73) Assignee: Matsushita Electric Industrial Co., Ltd., Kadoma-shi (JP)

(21) Appl. No.: 10/895,085

(22) Filed: Jul. 21, 2004

(30) Foreign Application Priority Data
Jul. 31, 2003 (JP) 2003-283744

(51) Int. Cl. H01M 2/18; H01M 10/04

(52) U.S. Cl. 429/144; 29/623.4

(57) ABSTRACT

A battery has an electrode with a mixture layer including electroactive material formed on a current collector whose exposed part is welded to a lead, and also a separator that shrinks with heat. In the battery, a heat shrinkage-preventing layer is provided on a portion of the separator that faces the lead. As a result, even if a minor short-circuit occurs and a large amount of current is flown to a minor short-circuit region, the heat shrinkage-preventing layer prevents expansion of a short-circuit area resulting from heat shrinkage of the separator. Thus, a conspicuous decrease in battery properties is prevented.

### TECHNICAL FIELD

The present invention relates to a battery having an electrode including a mixture layer containing electroactive material formed on a current collector whose exposed part is welded to a lead, and also having a separator that shrinks with heat.

### BACKGROUND ART

A battery which is required high power output has a pair of electrodes each including a metal foil current collector, an electrode mixture layer containing electroactive active material formed on the current collector and a lead welded to a metal foil exposed part of the current collector. These electrodes are opposed to each other with a heat-shrinking separator therebetween and are wound together. In such a battery, occurrence of an internal short-circuit tends to be concentrated where the lead is coupled with the current collector by welding or the like.

One cause for the concentrated internal short-circuit is a burr developing on the section of the lead when it is cut or processed, or an asperity developing during lead welding (the burr and the asperity are hereinafter referred to as “lead burr”). Lead burrs break through the separator while the battery is being assembled, transported, or operated, thereby causing an electric path. Such an electric path (hereinafter referred to as a minor short-circuit) is unstable, and lead burrs are generally not in contact with the opposing electrode. Or only a minor current of several microamperes or less flows between the lead burrs and the opposing electrode. Therefore, no inconvenience is caused to the battery, making it difficult to detect the presence of a minor short-circuit before the use of the battery. While the battery is used for a long period of time, however, an open circuit voltage may slightly decrease or a voltage may have noise during operation of the battery.

Various measures have been suggested. Japanese Patent Application Unexamined Publication No. H11-265703 discloses reducing the occurrence of lead burrs by applying chamfering to the side corners of the lead. Japanese Utility Model Laid-Open No. H10-112562 discloses covering the portion where the lead faces the counter electrode with a multi-layer insulating sheet formed by bonding two or more insulating sheets together. Japanese Patent Application Unexamined Publication No. H10-302751 discloses covering the lead with an insulating tape except for a portion to be welded to the current collector and a portion to be welded to a metal part for connecting with a battery terminal. Japanese Patent Application Unexamined Publication No. H11-135097 discloses providing a reinforcing layer onto the portion of the separator that comes into contact with the lead.

However, although these conventional arts have reduced the occurrence of minor short-circuits, it is still impossible to prevent it altogether. Therefore, in spite of these measures, some batteries cause minor short-circuits due to lead burrs. In such a battery, a short-circuit current of several amperes or more is flown to a minor short-circuit region while the battery is being transported or operated and in particular during charge and discharge because of expansion and contraction of the electrodes. Consequently, the temperature in the vicinity of the minor short-circuit region rises to shrink the portion of the separator that is around the short-circuit region, thereby increasing the size of a hole formed during the minor short-circuit and expanding the short-circuit area. The expansion of the short-circuit area results in a conspicuous decrease in battery properties, such as a large drop in battery voltage crossing the range of the operating voltage in a short period of time, or a rise in battery temperature.

### SUMMARY OF THE INVENTION

A battery of the present invention has an electrode including a mixture layer formed on a current collector whose exposed part is welded to a lead, and also has a separator that shrinks with heat. This battery is provided with a heat shrinkage-preventing layer on the portion of the separator that faces the lead. The heat shrinkage-preventing layer functions to prevent the expansion of a short-circuit area resulting from the heat shrinkage of the separator, even when a lead burr causes a minor short-circuit and a short-circuit current of several amperes or more is flown to the minor short-circuit region. As a result, a conspicuous decrease in battery properties due to a short circuit is prevented extremely effectively.

### BRIEF DESCRIPTION OF THE DRAWINGS

FIG. 1 is a schematic plan view showing a battery according to an embodiment of the present invention.

FIGS. 2 and 3 are schematic cross sectional views each showing a structure of the battery and a minor short-circuit due to a lead burr according to the embodiment of the present invention.

### DETAILED DESCRIPTION OF PREFERRED EMBODIMENT

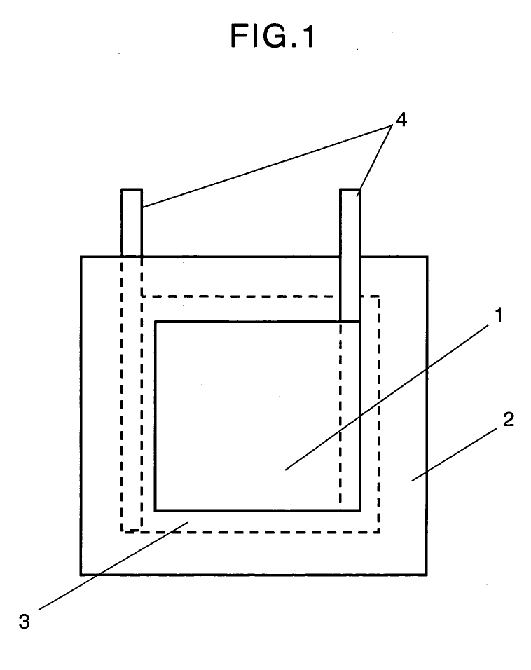

FIG. 1 is a schematic plan view showing a lithium ion secondary battery according to an embodiment of the present invention. Positive electrode plate (cathode) 1 and negative electrode plate (anode) 3 are sheet-like and each formed by applying a mixture containing electroactive material onto a metal foil that is a current collector. Cathode 1 and anode 3 are disposed opposed to each other with separator 2 therebetween, and an electrolytic solution is filled into pores in cathode 1 and anode 3 and the space between these electrode plates. Namely, cathode 1 is a first electrode, and anode 3 is a second electrode which is disposed opposed to the first electrode and which has a different polarity from the first electrode. Separator 2 is disposed between the first electrode and the second electrode. These components are collectively housed in an aluminum laminate pack (not illustrated) and sealed. On cathode 1 and anode 3, leads 4 are welded to the respective metal foil exposed parts of these electrode plates.

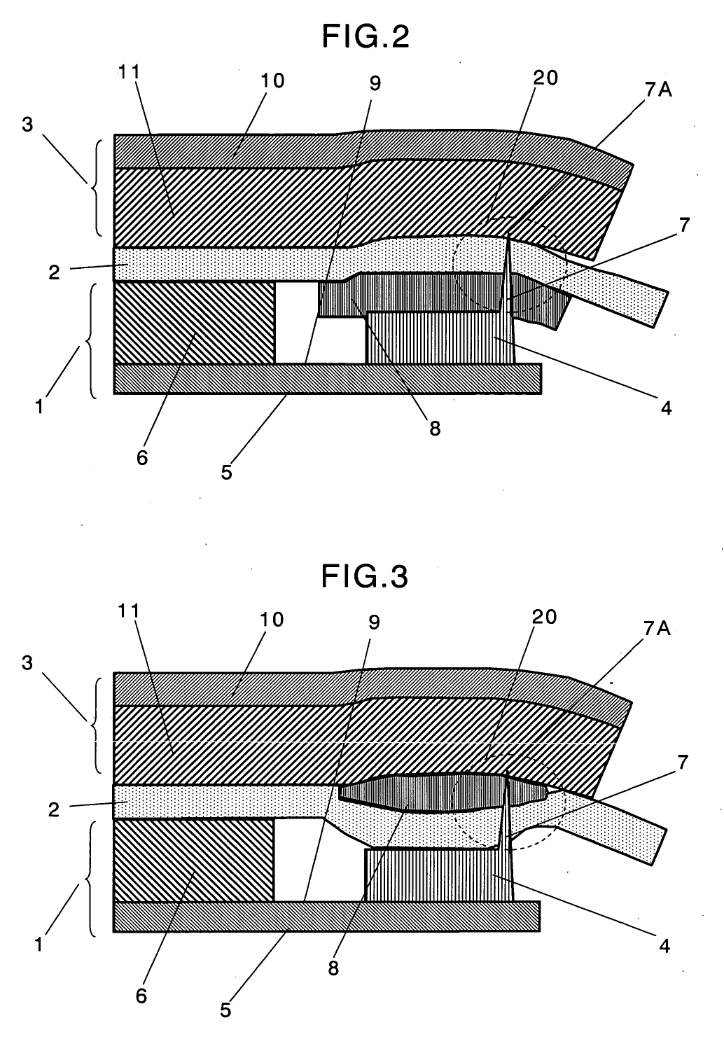

FIG. 2 is a cross sectional view in the vicinity of the lead area of cathode 1. Cathode 1 includes positive mixture layer 6 formed on positive electrode current collector 5 made of metal foil, and lead 4 welded to exposed part 9 of current collector 5. Lead burr 7, which has developed during the processing of lead 4, is on a surface end of lead 4, and tip part 7A of lead burr 7 faces separator 2. Heat shrinkage-preventing layer 8 made of a tape is provided between lead 4 and separator 2 facing lead 4, and is pasted fixedly on separator 2.

Anode 3 includes negative mixture layer 11 formed on negative electrode current collector 10 made of metal foil. Cathode 1, separator 2 and anode 3 together function as a battery by filling the spaces between them with an electrolytic solution. Separator 2 is a heat-shrinking separator for batteries, such as a microporous resin film or a nonwoven made of resin. In this kind of separator, when the internal temperature of the battery exceeds the shutdown temperature at an emergency such as an external short-circuit of the battery, pores in the separator close to provide electrochemical isolation between the positive electrode and the negative electrode. Heat shrinkage-preventing layer 8 has a heat resistance temperature which is not lower than the shutdown temperature of separator 2 so as to prevent the heat shrinkage of the portion of separator 2 that faces heat shrinkage-preventing layer 8. Heat shrinkage-preventing layer 8 is also resistant to electrolytic solution.

The following is a description of actions of the aforementioned structure in the state of having a minor short-circuit. Lead burr 7 breaks through heat shrinkage-preventing layer 8 and separator 2 as far as tip part 7A reaches near the border between separator 2 and anode 3, thereby causing a minor short-circuit. Thus, the minor hole caused by lead burr 7 in minor short-circuit region 20 of separator 2 enables the flow of a minor current of several microamperes or less.

If a short-circuit current of several amperes or more is flown to minor short-circuit region 20 for some reason, then separator 2 in region 20 shrinks with the generated heat. As a result, the minor hole developed in minor short-circuit region 20 is grown as large as several millimeters in diameter, thereby causing separator 2 to shrink around minor short-circuit region 20.

However, heat shrinkage-preventing layer 8 made of a tape is pasted fixedly on the portion of separator 2 in the vicinity of minor short-circuit region 20. The presence of heat shrinkage-preventing layer 8 reduces heat shrinkage so as to prevent the hole in minor short-circuit region 20 from growing larger around lead burr 7. In addition, since a short-circuit current of several amperes or more is concentrated on tip part 7A of lead burr 7, tip part 7A is fused immediately after a short-circuit by the heat generated during the short-circuit. Therefore, a hole in separator 2 would not keep the short-circuit state. The aforementioned actions prevent short-circuit expansion, thereby avoiding a conspicuous decrease in battery properties.

Heat shrinkage-preventing layer 8 is pasted on the side of separator 2 that faces lead 4 in the present embodiment; however, this is not the only structure possible in terms of the actions of heat shrinkage-preventing layer 8, and as shown in FIG. 3, heat shrinkage-preventing layer 8 can be pasted on the other side of separator 2. In either case, heat shrinkage-preventing layer 8 can be pasted not just on the portion of separator 2 that faces lead 4 but on a wider portion of separator 2 so as to cover the lead 4. This structure can increase the area for fixing separator 2 by heat shrinkage-preventing layer 8, thereby further securing the fixation of separator 2 and also improving the effect of preventing a hole growth during a short-circuit.

The present embodiment describes a lead burr in the positive electrode; however, the same structure can be used for a lead burr in the negative electrode to obtain the same effects.

As long as a battery satisfies the aforementioned structure and does not greatly deviate from the objects of the present invention, the same effects can be obtained regardless of details such as the type of the battery and the material of heat-shrinkage preventing layer 8. In other words, the same effects can be obtained from any batteries having at least an electrode including a current collector having a metal foil exposed part to which a lead is welded, and an mixture layer containing electroactive material formed on the current collector, and also having a separator that shrinks with heat. These batteries include nickel-hydrogen storage batteries and nickel-cadmium storage batteries. These batteries also include batteries with a lithium metal as the negative electrode and primary batteries. Current collectors 5 and 10 may be an expanded metal or a metal mesh, besides a metal foil.

Heat shrinkage-preventing layer 8 can be an insulating and heat resistant tape, such as a polyimide-based tape with a heat-resistant adhesive like a silicone-based adhesive. The term “heat resistant” as used herein indicates the material or property of not melting and only causing a small degree of heat shrinkage at a temperature of around 120° C. which the whole battery reaches at the time of an internal short-circuit. Thus, heat shrinkage-preventing layer 8 can be properly selected depending on the type of the battery used.

As another method for providing heat shrinkage-preventing layer 8 to separator 2, it is possible to coat aramid resin onto the surface of the portion of separator 2 that opposites the portion where lead 4 is welded to current collector 5. It is also possible to provide heat shrinkage-preventing layer 8 in a manner to coat and impregnate a solvent containing resin, such as polyvinylidene fluoride, onto the portion of separator 2 that opposites the portion where lead 4 is welded to current collector 5, and to dry the resin. Heat shrinkage-preventing layer 8 is also possibly provided in a manner to coat and impregnate a mixture of a photocuring resin such as methacrylate with a polymerization initiator, and to polymerize it. These resins can be any kind as long as they are heat resistant against the shutdown temperature of separator 2 and are also resistant to electrolytic solution.

A specific example of the present embodiment will be described as follows. Anode 3 is prepared as follows. First of all, 97 wt % of graphite is mixed with 3 wt % of styrene butadiene rubber as a binder. The resultant mixture is dispersed in a 1% aqueous solution of carboxymethylcellulose so as to prepare slurry. The slurry is applied on one side of current collector 10 made of copper foil and then dried so as to form mixture layer 11. The dry sheet member thus obtained is pressed with a roll press so as to prepare a negative electrode sheet. The graphite used here is powdered graphite which has a specific surface of 2.4 m²/g and a grain size of 15 to 22 μm when measured with a wet-type laser grain-size analyzer, and which is obtained by performing pulverization with a turbo mill and grain size control.

The obtained negative electrode sheet is cut into a size of 6.5 cm×6.5 cm, and mixture layer 11 is skinned by a width of 5 mm from one side of mixture layer 11 using a spatula so as to form a metal exposed part. A nickel foil with 10 cm in length, 5 mm in width and 50 μm in thickness is spot-welded as a lead to the metal exposed part. Thus, anode 3 is obtained.

Cathode 1, on the other hand, is prepared as follows. First of all, 7.4 wt % of carbon powder as a conductive agent and 29.6 wt % of 1-methyl-2-pyrrolidone (NMP) solution containing 12.5 wt % of carboxymethylcellulose dispersed therein are mixed with 63 wt % of lithium cobalt oxide powder, and then kneaded to prepare slurry. The slurry is coated onto one side of current collector 5 made of aluminum foil with a thickness of 15 μm, dried and rolled to form a positive electrode sheet having a mixture layer of 100 μm thickness.

The obtained positive electrode sheet is cut into a size of 5 cm×5 cm, and mixture layer 6 is skinned by a width of 12 mm from one side of mixture layer 6 using a spatula so as to form exposed part 9. Lead 4 made of aluminum and cut into a size of 10 cm in length and 5 mm in width is disposed on exposed part 9 in such a manner as to project by 5.5 cm from cathode 1. Then, lead 4 is welded in a 3 mm width to exposed part 9 by ultrasonic welding at the center in the width direction of lead 4. Thus, cathode 1 is obtained. It is possible to provide exposed part 9 by previously forming a part with no slurry applied thereon on current collector 5. The exposed part on anode 3 can be formed in the same manner.

Separator 2 used here is a polyethylene microporous resin film having a size of 8 cm×8 cm and a thickness of 25 μm and a shutdown temperature of 120° C.

Lead 4 is prepared by cutting a 50 μm-thick aluminum foil into a size of 10 cm in length and 5 mm in width using a cutting machine with a gap of 0.05 mm between blades. In the obtained lead, burrs with a height of 0.06 mm at the maximum are observed on the end in a direction of the lead width surface with a laser microscope.

Next, cathode 1 thus obtained is placed on a horizontal board, and heat shrinkage-preventing layer 8 of 7 cm in length and 7 mm in width is formed on the surface of the portion of separator 2 that faces lead 4. When a tape is used as heat shrinkage-preventing layer 8, the tape is pasted in such a manner as to avoid the direct contact between lead 4 and separator 2.

Later, anode 3 is laid on separator 2 to form an electrode group. At that time, the center of cathode 1 agrees with the center of anode 3, and the lead welds of these electrode plates are located in opposite sides each other and the surfaces applied with the mixtures face to each other. The obtained electrode group is put into an aluminum laminate film shaped into a bag of 10 cm in height and 8 cm in width having an opening. Then, an organic electrolytic solution is filled into the bag under a low pressure, and the opening is heat welded. Thus, the lithium ion battery as shown in FIG. 1 is obtained.

The aforementioned organic electrolytic solution is prepared by adding 1.5 mol/liter of LiPF₆ to a mixture solvent of ethylene carbonate and ethyl carbonate in a volume ratio of 1:1.

The following is a description of variations in heat shrinkage-preventing layer 8. A polyimide tape with a thickness of 50 μm and a heat resistance temperature of 410° C. is used in Sample 1. A vinyl chloride tape with a thickness of 50 μm and a heat resistance temperature of 130° C. is used in Sample 2. A polyetherimide resin tape with a thickness of 50 μm and a heat resistance temperature of 280° C. is used in Sample 3. A polyphenylene sulfide tape with a thickness of 50 μm and a heat resistance temperature of 285° C. is used in Sample 4.

In Samples 5 and 6, heat shrinkage-preventing layer 8 is formed by coating polymer solutions as described below into an area of 7 cm in length and 7 mm in width on the surface of the portion of separator 2 that faces lead 4, and by drying the coating with a hot blast of 70° C. so as to remove the solvents. An NMP solution containing 10 wt % of polyvinylidene fluoride is used in Sample 5. Epoxy resin is used in Sample 6.

In Sample 7, heat shrinkage-preventing layer 8 is formed by impregnating ultraviolet-curing silicone resin into an area of 7 cm in length and 7 mm in width on the surface of the portion of separator 2 that faces lead 4, and by curing it with ultraviolet radiation. The heat resistance temperatures of heat shrinkage-preventing layer 8 in Samples 5, 6 and 7 are 180° C., 220° C. and 180° C., respectively.

A polyethylene-naphthalate tape with a thickness of 50 μm and a heat resistance temperature of 265° C. is used in Sample 8. A polyether-sulfone tape with a thickness of 50 μm and a heat resistance temperature of 225° C. is used in Sample 9. A polyether-ketone tape with a thickness of 50 μm and a heat resistance temperature of 334° C. is used in Sample 10. A polytetrafluoroethylene tape with a thickness of 50 μm and a heat resistance temperature of 327° C. is used in Sample 11. The heat resistance temperature as used herein stands for a temperature where heat shrinkage-preventing layer 8 doesn't melt or shrink. Namely, heat shrinkage-preventing layer 8 melts or shrinks if the temperature exceeds it.

As Comparative Samples, batteries according to Sample 1 are prepared without providing heat shrinkage-preventing layer 8. In Comparative Sample 1, heat shrinkage-preventing layer 8 is replaced by a polyimide tape with a length of 7 cm, a width of 7 mm, a thickness of 50 μm and a heat resistance temperature of 410° C., and the polyimide tape is directly pasted on lead 4. In Comparative Sample 2, the adhesive part of the polyimide tape of Comparative Sample 1 is removed, and the remaining member of the tape is used in place of heat shrinkage-preventing layer 8.

A hundred batteries for each of Samples 1 to 11 and Comparative Samples 1 and 2 thus obtained are manufactured and evaluated as follows.

Each battery is put on a horizontal surface with the negative electrode down and the positive electrode up, and a 50 g metal plate is placed on the battery from above in such a manner to cover these electrodes to apply pressure onto the electrodes. In this state, a charge-discharge cycle test is performed to check changes in battery voltage and battery surface temperature during the test.

The charge-discharge cycle test is performed as follows. The batteries are charged with a current of 10 mA in a constant-temperature bath of 20° C. until the voltage reaches 4.2V, and then charged at a charging voltage of 4.2V until the current reaches 1 mA. After a half-hour interval, the batteries are discharged with a current of 10 mA until the voltage reaches 3.0V. When the discharge is over, the batteries are charged again after a half-hour interval. This sequence of charge and discharge is repeated 20 times.

During the charge-discharge cycle test, battery voltage and battery surface temperature are measured. The battery surface temperature is measured by placing a thermocouple on the battery surface. The batteries which have shown a drop in battery voltage to 0.5V or below during the charge-discharge cycle test are regarded to have short-circuited, and the test is suspended. The batteries, which have shown a drop in battery voltage of 0.5V or larger than the voltage at the time of the normal charge-discharge cycles for as short a period of time as several tens of microseconds (hereinafter referred to as a state “A”) during the charge-discharge cycle test, are continued to be tested. The numbers of the batteries which have short-circuited and the batteries which have entered the state “A” during the charge-discharge cycle test are shown in Table 1.

TABLE 1

| | the number of | the number of |
|---|---|---|
| | short-circuited | batteries entered |
| | batteries | the state “A” |
| Sample 1 | 0 | 7 |
| Sample 2 | 0 | 10 |
| Sample 3 | 0 | 6 |
| Sample 4 | 0 | 5 |
| Sample 5 | 0 | 8 |
| Sample 6 | 0 | 9 |
| Sample 7 | 0 | 11 |
| Sample 8 | 0 | 8 |
| Sample 9 | 0 | 9 |
| Sample 10 | 0 | 8 |
| Sample 11 | 0 | 8 |
| Comparative Sample 1 | 38 | 0 |
| Comparative Sample 2 | 56 | 0 |

Samples 1 to 11 include no batteries that have short-circuited and shown a drop in battery voltage to 0.5V or below during the charge-discharge cycle test; however, Comparative Samples 1 and 2 include batteries that have shown a drop in battery voltage to 0.5V or below and a drastic rise in temperature. On the other hand, Samples 1 to 11 include batteries that have entered the state “A”; however, Comparative Samples 1 and 2 include no such batteries.

Of the batteries of Samples 1 to 11 and Comparative Samples 1 and 2, the batteries that have not short-circuited, the batteries that have short-circuited and the batteries that have entered the state “A” have been exploded after the charge-discharge cycle test. The results of observation with an optical microscope are shown as follows.

In the batteries that have not short-circuited, the separators show no large change. The reason for this seems to be that although lead 4 has lead burr 7, no short-circuit has occurred or only a minor short-circuit has occurred.

Of the batteries of Comparative Samples 1 and 2, separator 2 of each of the batteries that have short-circuited has a hole with a radius of 1.5 cm or larger in the portion of separator 2 that faces lead 4, and positive mixture layer 6 and negative mixture layer 11 are in direct contact with each other via the hole. In some of the batteries, shrinkage of separator 2 is observed around the hole due to the heat generated at the time of a short-circuit. In lead 4, tip part 7A of lead burr 7 is fused.

From the situation described hereinbefore, the batteries that have short-circuited are considered to have shown a drop in battery voltage to 0.5V or below through the following process. During the charge-discharge cycle test, lead burr 7 breaks through separator 2 and reaches anode 3, thereby causing the batteries to have an internal short-circuit. A large current of several amperes flowing at that moment is concentrated on tip part 7A, thereby causing tip part 7A to generate heat. The temperature locally reaches as high a level as fusing lead burr 7, so that separator 2 is also affected by the heat. As a result, lead burr 7 causes a hole in separator 2, and the hole grows larger when separator 2 shrinks with heat. Since tip part 7A of lead burr 7 has been fused, the short-circuit in that region does not continue. However, the hole in separator 2 grows larger so as to cause mixture layer 6 of cathode 1 to be exposed and short-circuited with anode 3 that is opposed to mixture layer 6, thereby continuing the short-circuit. Hence, the battery voltage drops to 0.5V or below.

On the other hand, of the batteries of Samples 1 to 11, in the batteries that have entered the state “A”, separator 2 has a hole with a radius of about 1.5 mm in the portion of separator 2 that faces lead 4. Or separator 2 has melt and become transparent in the area of a radius of about 1.5 mm. In other words, unlike the short-circuited batteries of Comparative Samples 1 and 2, there are no batteries in which separator 2 has as large a hole as a radius of 1.5 cm. Even when there is a hole of about 1.5 mm in radius, the hole remains within the vicinity of lead 4, without causing mixture layer 6 and mixture layer 11 to come into direct contact with each other via the hole. In addition, tip part 7A of lead burr 7 is fused.

From the aforementioned situation, the batteries that have entered the state “A” seem to have entered the state “A” through the following process. During the charge-discharge cycle test, lead burr 7 breaks through separator 2 and reaches anode 3, thereby causing the batteries to have an internal short-circuit. A large current of several amperes flowing at that moment is concentrated on tip part 7A, thereby causing tip part 7A to generate heat. The temperature reaches as high a level as fusing lead burr 7, so that separator 2 is also affected by the heat. As a result, lead burr 7 causes a hole in separator 2, and separator 2 is going to shrink with heat. Then separator 2 has a hole with a radius of about 1.5 mm, but the hole is prevented from growing larger by the presence of heat shrinkage-preventing layer 8. Consequently, no internal short-circuit occurs due to the direct contact between cathode 1 and anode 3 via the hole.

Since tip part 7A of lead burr 7 has been fused, the short-circuit in that region does not continue. Therefore, the battery voltage momentarily drops by 0.5V or larger, but the internal short-circuit occurs only at that moment, so the charge-discharge cycle test is continued.

As described above, when lead burr 7 has caused a large current of several amperes to be flown to minor short-circuit region 20, heat shrinkage-preventing layer 8 reduces heat shrinkage in separator 2 around region 20, thereby preventing the battery from being short-circuited. Heat shrinkage-preventing layer 8 can be formed by pasting a heat resistant tape on the portion of separator 2 that faces lead 4, or by impregnating heat resistant resin onto separator 2.

When a heat resistant tape is pasted on separator 2 as in Samples 1 to 4 and Samples 8 to 11, it is preferable to use a heat resistant tape provided with an adhesive part on both sides thereof. Using such a tape can facilitate the positioning heat shrinkage-preventing layer 8 against lead 4.

In the above description, cathode 1 and anode 3 are formed like flat sheets; however, battery structure is not limited in such one. It is possible to wind cathode 1 and anode 3 with separator 2 therebetween to obtain the same effects.

According to a battery of the present invention, a separator is prevented from shrinking with heat even when a lead burr causes a minor short-circuit and a large amount of current is flown to a minor short-circuit region. Hence, short-circuit expansion is prevented, and a conspicuous decrease in battery properties due to a short-circuit is effectively prevented. This structure is useful for batteries using a separator that shrinks with heat, such as lithium ion secondary batteries and lithium primary batteries.

1. A battery comprising:
a first electrode including:
a current collector made of metal, the current collector having an exposed part;
a mixture layer including electroactive material formed on the current collector except for the exposed part; and
a lead welded to the exposed part;
a second electrode disposed opposed to the first electrode, and having a different polarity from the first electrode;
a separator disposed between the first electrode and the second electrode, the separator shrinking with heat;
a heat shrinkage-preventing layer disposed on a portion of the separator that faces the lead so as to prevent heat shrinkage of the portion; and
an electrolytic solution filled in spaces between the first electrode, the separator, and the second electrode.

2. The battery according to claim 1, wherein the heat shrinkage-preventing layer is a tape pasted on the separator.

3. The battery according to claim 2, wherein the tape is provided with adhesive parts on both sides thereof.

4. The battery according to claim 1, wherein the heat shrinkage-preventing layer is a resin layer provided on the separator.

5. The battery according to claim 1, wherein the separator provides electrochemical isolation between the first electrode and the second electrode at a temperature not lower than a shutdown temperature, and the heat shrinkage-preventing layer is resistant to heat higher than the shutdown temperature.

6. A method for manufacturing a battery, comprising the steps of:
A) forming a first electrode with making a mixture layer including electroactive material onto a current collector made of metal and an exposed part of the current collector;
B) welding a lead to the exposed part;
C) disposing a separator, which shrinks with heat, between the first electrode and a second electrode having a different polarity from the first electrode;
D) forming a heat shrinkage-preventing layer on a portion of the separator that faces the lead; and
E) filling an electrolytic solution into spaces between the first electrode, the separator, and the second electrode.

7. The method for manufacturing the battery according to claim 6, wherein in step D, the heat shrinkage-preventing layer is formed by pasting a tape on the portion of the separator that faces the lead.

8. The method for manufacturing the battery according to claim 6, wherein in step D, the heat shrinkage-preventing layer is formed by one of coating and impregnating resin onto the portion of the separator that faces the lead.
